(19) United States
(12) Patent Application Publication
(10) Pub. No.: US 2025/0156619 A1
(43) Pub. Date: May 15, 2025

(54) MULTI-FET VERTICAL STACK MODELING

(71) Applicant: International Business Machines Corporation, Armonk, NY (US)

(72) Inventors: Terence B. Hook, Jericho Center, VT (US); Henry Trombley, Starksboro, VT (US)

(21) Appl. No.: 18/508,272

(22) Filed: Nov. 14, 2023

(51) Int. Cl. G06F 30/367; G06F 119/08

(52) U.S. Cl. CPC G06F 30/367; G06F 2119/08

(57) ABSTRACT

Techniques are provided for multi-FET vertical stack modeling. In one embodiment, the techniques involve generating a first thermal equivalence circuit model of a first transistor of a vertical stack configuration, wherein the first thermal equivalence circuit model includes a first thermal impedance, generating a second thermal equivalence circuit model of a second transistor of the vertical stack configuration, wherein the second thermal equivalence circuit model includes a second thermal impedance, generating a compact model based on the first thermal equivalence circuit model and the second thermal equivalence circuit model, determining, based on the compact model and transistor data, the first thermal impedance and the second thermal impedance, and determining, based on the compact model and the transistor data, a third thermal impedance, wherein the third thermal impedance represents a shared thermal impedance of the first thermal equivalence circuit model and the second thermal equivalence circuit model.

### BACKGROUND

The present disclosure relates to stacked field-effect transistors (FETs), and more specifically, to thermal and electrical modeling of multiple vertically stacked FETs that share a gate network.

Traditional approaches to stacking FETs involve positioning the FETs side-by-side (i.e., horizontally or laterally), such that the operation of one FET has minimal interference with the operation of an adjacent FET. In this lateral FET configuration, heat can dissipate from each FET without significantly impacting the operation of adjacent FETs. Conventional modeling techniques can accurately represent the heat dissipation and gate resistance of individual FETs of the lateral FET configuration. However, in a vertical stack FET configuration, the operation of one FET can affect the operation of vertically adjacent FETs due to current flow through shared gate networks. Further, heat dissipated from one FET of a vertical stack FET configuration can flow upwards or downwards into a vertically adjacent FET, which can further affect operations of the vertical stack FET configuration. The shared gate resistance and heat dynamics cannot be accurately modeled using representations of individual or independent FETs. Therefore, conventional modeling techniques cannot be used to accurately model and determine the gate resistance and heat dynamics of vertically stacked FETs.

### SUMMARY

A method is provided according to one embodiment of the present disclosure. The method includes generating a first thermal equivalence circuit model of a first transistor of a vertical stack configuration, where the first thermal equivalence circuit model includes a first thermal impedance; generating a second thermal equivalence circuit model of a second transistor of the vertical stack configuration, where the second thermal equivalence circuit model includes a second thermal impedance; generating a compact model based on the first thermal equivalence circuit model and the second thermal equivalence circuit model; determining, based on the compact model and transistor data, the first thermal impedance and the second thermal impedance; and determining, based on the compact model and the transistor data, a third thermal impedance, where the third thermal impedance represents a shared thermal impedance of the first thermal equivalence circuit model and the second thermal equivalence circuit model.

A system is provided according to one embodiment of the present disclosure. The system includes a processor; and memory or storage comprising an algorithm or computer instructions, which when executed by the processor, performs an operation that includes generating a first thermal equivalence circuit model of a first transistor of a vertical stack configuration, where the first thermal equivalence circuit model includes a first thermal impedance; generating a second thermal equivalence circuit model of a second transistor of the vertical stack configuration, where the second thermal equivalence circuit model includes a second thermal impedance; generating a compact model based on the first thermal equivalence circuit model and the second thermal equivalence circuit model; determining, based on the compact model and transistor data, the first thermal impedance and the second thermal impedance; and determining, based on the compact model and the transistor data, a third thermal impedance, where the third thermal impedance represents a shared thermal impedance of the first thermal equivalence circuit model and the second thermal equivalence circuit model.

A computer-readable storage medium having computer-readable program code embodied therewith, the computer-readable program code executable by one or more computer processors to perform an operation, is provided according to one embodiment of the present disclosure. The operation includes generating a first thermal equivalence circuit model of a first transistor of a vertical stack configuration, where the first thermal equivalence circuit model includes a first thermal impedance; generating a second thermal equivalence circuit model of a second transistor of the vertical stack configuration, where the second thermal equivalence circuit model includes a second thermal impedance; generating a compact model based on the first thermal equivalence circuit model and the second thermal equivalence circuit model; determining, based on the compact model and transistor data, the first thermal impedance and the second thermal impedance; and determining, based on the compact model and the transistor data, a third thermal impedance, where the third thermal impedance represents a shared thermal impedance of the first thermal equivalence circuit model and the second thermal equivalence circuit model.

A system is provided according to one embodiment of the present disclosure. The system includes a processor; and memory or storage comprising an algorithm or computer instructions, which when executed by the processor, performs an operation that includes generating an electrical equivalence circuit model of a first transistor and a second transistor of a vertical stack configuration, where the electrical equivalence circuit model includes a gate network shared between the first transistor and the second transistor; generating a compact model based on the electrical equivalence circuit mode; and determining, based on the compact model and transistor data, impedances of the gate network.

A computer-readable storage medium having computer-readable program code embodied therewith, the computer-readable program code executable by one or more computer processors to perform an operation, is provided according to one embodiment of the present disclosure. The operation includes generating an electrical equivalence circuit model of a first transistor and a second transistor of a vertical stack configuration, where the electrical equivalence circuit model includes a gate network shared between the first transistor and the second transistor; generating a compact model based on the electrical equivalence circuit mode; and determining, based on the compact model and transistor data, impedances of the gate network.

### BRIEF DESCRIPTION OF THE DRAWINGS

FIG. 1 illustrates a computing environment, according to one embodiment.

FIG. 2 illustrates a modeling environment, according to one embodiment.

FIG. 3A illustrates a vertical stack configuration, according to one embodiment.

FIG. 3B illustrates an electrical equivalence circuit model of a vertical stack configuration, according to one embodiment.

FIG. 3C illustrates a thermal equivalence circuit models of a vertical stack configuration, according to one embodiment.

FIG. 4 illustrates a flowchart of a method of determining impedances of a shared gate network of an electrical equivalence circuit model of a vertical stack configuration, according to one embodiment.

FIG. 5 illustrates a flowchart of a method of determining thermal impedances of a thermal equivalence circuit model of a vertical stack configuration, according to one embodiment.

FIG. 6 illustrates a flowchart of a method of generating a thermal characteristic datasheet of the vertical stack configuration, according to one embodiment.

### DETAILED DESCRIPTION

Embodiments of the present disclosure improve upon multi-FET vertical stack modeling by providing a compact modeling (CM) module that accurately models inter-FET electrical and thermal dynamics of FETs in a vertical stack configuration. In one embodiment, the CM module generates a compact model that represents an electrical equivalence model and a thermal equivalence circuit models of FETs in the vertical stack configuration. The CM module can then simulate features of the compact model to determine optimal features of the vertical stack configuration. In one embodiment, the CM module uses sensor data or empirical data, or performs a finite element analysis of the vertical stack configuration to determine electrical features of the FETs (e.g., impedances of a shared gate network of the electrical equivalence circuit model) and thermal features of the FETs (e.g., a shared thermal impedance of the thermal equivalence circuit model). The shared thermal resistance can represent thermal dynamics of the vertically adjacent FETs that contribute to inter-FET temperatures. In addition, the CM module can generate a thermal characteristic datasheet of the FETs in the vertical stack configuration based on the temperature dynamics.

One benefit of the disclosed embodiments is to accurately determine thermal dynamics of FETs in a vertical stack configuration, which can be used to design improved vertical stack configurations and make accurate predictions of circuit functions and performance. Further, embodiments of the present disclosure can improve the accuracy, and decrease costs, of generating thermal characteristic datasheets of FETs in a vertical stack configuration.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

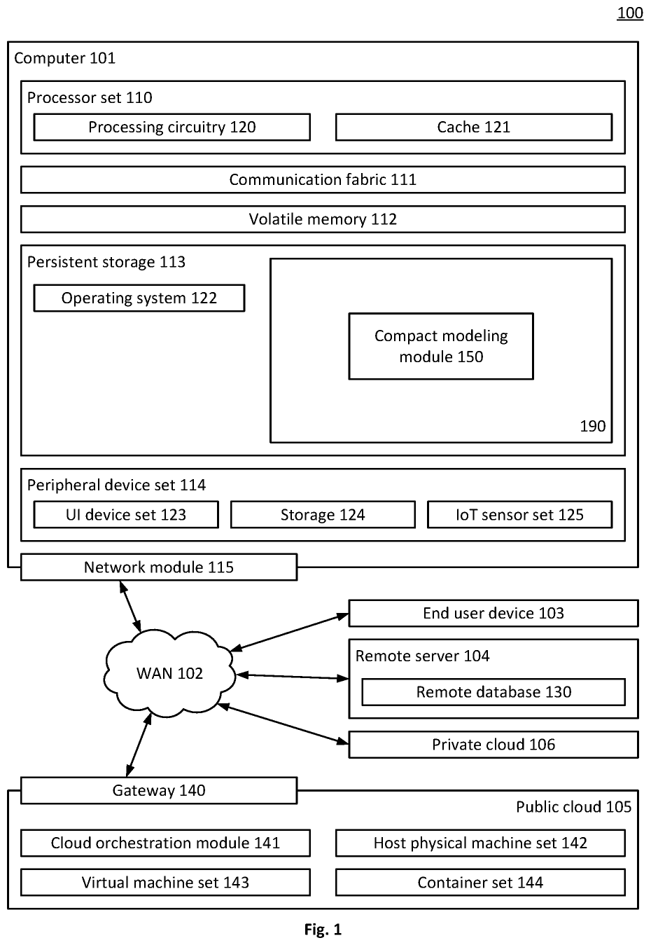

FIG. 1 illustrates a computing environment 100, according to one embodiment. Computing environment 100 contains an example of an environment for the execution of at least some of the computer code involved in performing the inventive methods, such as compact modeling module 150, shown in block 190. In addition to block 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

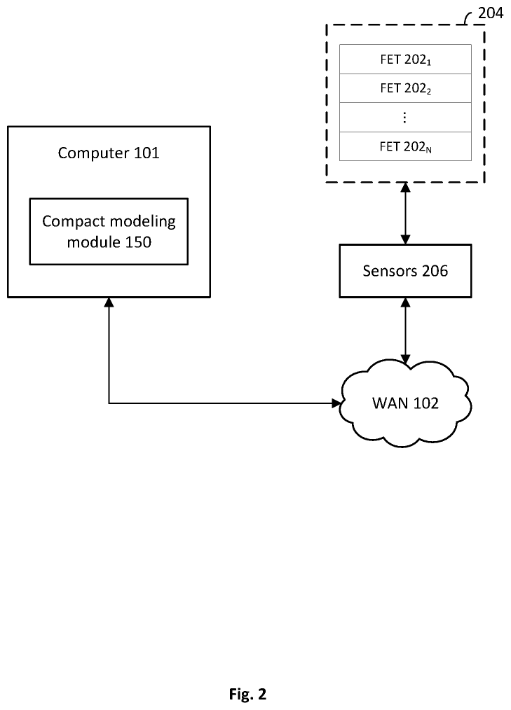

FIG. 2 illustrates a modeling environment 200, according to one embodiment. In the illustrated embodiment, the modeling environment 200 includes the computer 101, FETs 202_{1-N} arranged in a vertical stack configuration 204, and sensors 206, communicatively coupled to a WAN 102.

As previously described, the compact modeling (CM) module 150 can be stored in the persistent storage 113 of the computer 101. In one embodiment, the CM module 150 represents one or more algorithms, instruction sets, software applications, or other computer-readable program code that can be executed by the processor set 110 of the computer 101 to perform the functions, operations, or processes described herein.

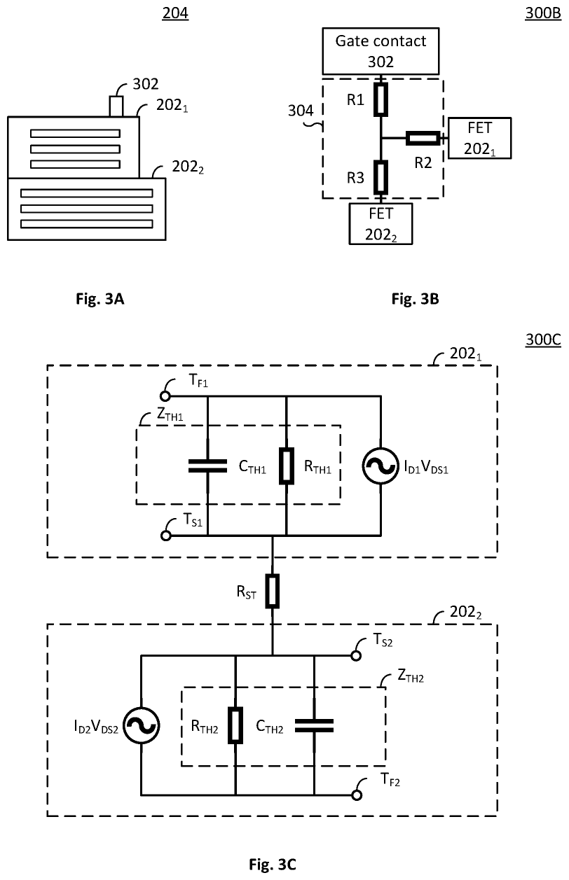

In one embodiment, the FETs 202_{1-N} are arranged in a vertical stack configuration 204, such that one FET is disposed on a topside or a bottom side of another FET. The FETs 202_{1-N} can share a gate network (not shown) that controls the power supplied to each of the FETs 202_{1-N}. In this manner, power supplied to one FET of the vertical stack configuration 204 can cause power to be supplied to another FET of the vertical stack configuration 204. Further, the operation of one FET can dissipate heat upwards or downwards to other FETs in the vertical stack configuration 204, thereby affecting the operation of vertically adjacent FETs. A vertical stack configuration 204 is described further in FIG. 3A below.

In one embodiment, the CM module 150 receives data from the sensors 206 arranged at various positions in contact with, or surrounding, the vertical stack configuration 204 to measure the heat dissipated from the FETs 202_{1-N}. Examples of the sensors 206 include thermocouples, thermistors, infrared temperature sensors or pyrometers, thermal imaging cameras, liquid crystal thermography sensors, micro-electro-mechanical system (MEMS) sensors, or the like.

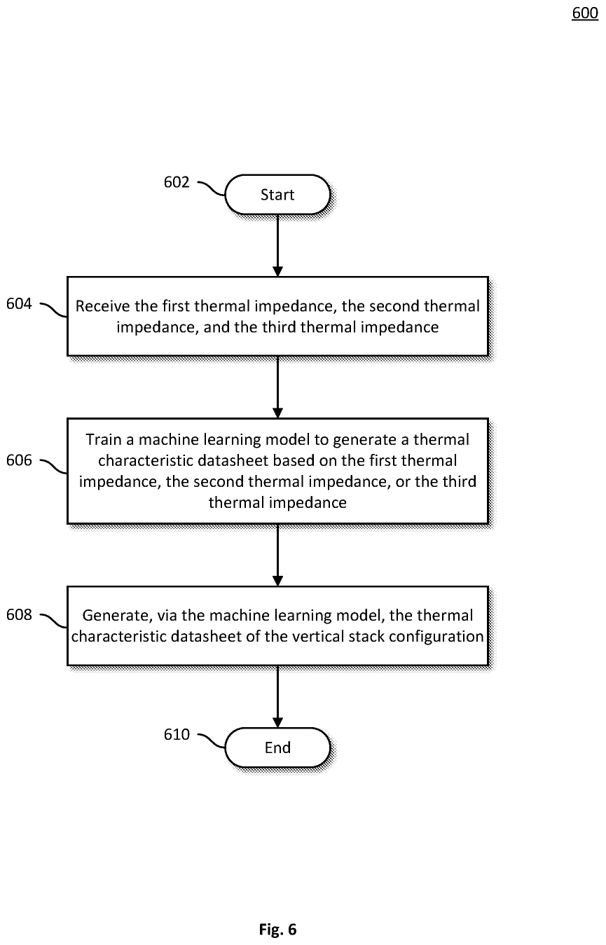

The CM module 150 can generate models of the FETs 202_{1-N} that represent electrical or thermal equivalence circuit models of the FETs 202_{1-N}, and use transistor data (e.g., the received sensor data, empirical data, or model data) to capture electrical features of the FETs 202_{1-N} and temperature dynamics of the heat dissipated from the FETs 202_{1-N}. The temperature dynamics can include, for instance, transient heat dynamics that represent heat dissipated from the FETs 202_{1-N} at the start of a FET operation, and ongoing heat dynamics that represent heat dissipated from the FETs 202_{1-N} after an initial operation period. The models and processes are described further in FIGS. 3B-3C and FIGS. 4-5 below. Further, processes for generating a thermal characteristic datasheet of the vertical stack configuration are described in FIG. 6.

References may be made herein to a given number of FETs (e.g., FET 202₁ and FET 202₂), however, embodiments of the present disclosure can include any of the FETs 202_{1-N} of the vertical stack configuration 204.

FIG. 3A illustrates a vertical stack configuration 204, according to one embodiment. In the illustrated embodiment, FET 202₁ and FET 202₂ represent gate-all-around transistors, which each include 3 nanosheets along a z-axis (extending into and out of the page). The nanosheets can include an active region of the transistor that includes sources, drains, and channels.

In one embodiment, each FET of the vertical stack configuration 204 represents an n-type FET or a p-type FET. In one embodiment, FET 202₁ represents a p-FET, and FET 202₂ represents an n-FET.

As shown, a gate contact 302 can be disposed on FET 202₁, which is disposed on FET 202₂. In one embodiment, additional FETs may be added to the vertical stack configuration 204 from the bottom of FET 202₂.

The gate contact 302 can be shared between the FETs such that the gate contact 302 can be used to control the operation of FET 202₁ and FET 202₂. In one embodiment, supplying power to one FET can affect the power supplied to another FET. For instance, when gate contact 302 is used to enable power flow to FET 202₂, the power also flows through FET 202₁.

During operation, FET 202₁ can radiate heat upwards into a surrounding environment, and downward into FET 202₂. The heat radiated from FET 202₁ can affect the operation of FET 202₂. Further, during operation, FET 202₂ can radiate heat upwards into FET 202₁, and downwards into the surrounding environment. The heat radiated from FET 202₂ can affect the operation of FET 202₁.

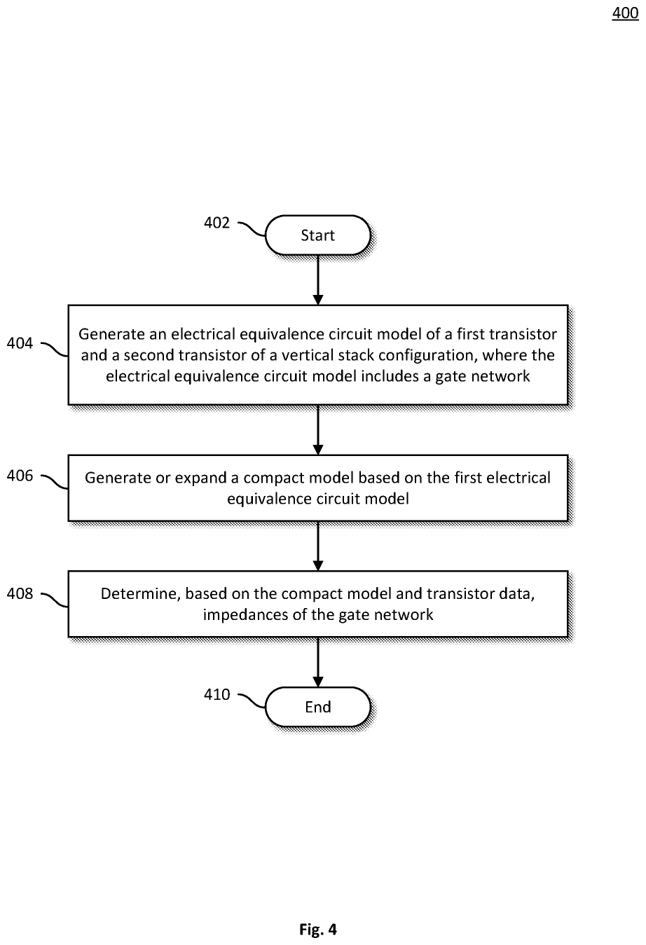

FIG. 3B illustrates an electrical equivalence circuit model 300B of a vertical stack configuration 204, according to one embodiment. FIG. 4 illustrates a flowchart of a method 400 of determining impedances of a gate network 304 of an electrical equivalence circuit model 300B of a vertical stack configuration 204, according to one embodiment. FIG. 3B is described in conjunction with FIG. 4.

In one embodiment, the method 400 is performed by the compact modeling (CM) module 150. The method 400 begins at block 402.

At block 404, the CM module 150 generates an electrical equivalence circuit model 300B of a first transistor and a second transistor of a vertical stack configuration 204, where the electrical equivalence circuit model 300B includes a gate network 304. In the embodiment illustrated in FIG. 3B, the electrical equivalence circuit model 300B includes a gate contact 302 is connected to FET 202₁ via a first electrical path that includes shared resistor R1 and resistor R2. The gate contact 302 is also connected to FET 202₂ via a second electrical path that includes shared resistor R1 and resistor R3.

In one embodiment, a gate network 304 is represented by shared resistor R1, resistor R2, and resistor R3. However, the gate network 304 may also be represented by any combination of circuit elements.

Additional FETs may be added to the electrical equivalence circuit model 300B by attaching the FETs via corresponding resistors to the common node shared by shared resistor R1, resistor R2, and resistor R3. In one embodiment, each resistor of the gate network 304 can represent a dimension (length or width) of FET 202₁ or FET 202₂.

At block 406, the CM module 150 generates or expands a compact model based on the first electrical equivalence circuit model. In one embodiment, a compact model is a simulation model that represents electrical or thermal features of a transistor. In the embodiment illustrated in FIG. 3B, the compact model represents the electrical equivalence circuit model 300B. However, the compact model can be expanded to further represent the thermal equivalence circuit model 300C, such that the compact model represents both the electrical equivalence circuit model 300B and the thermal equivalence circuit model 300C.

At block 408, the CM module 150 determines, based on the compact model and transistor data, impedances of the gate network 304. In one embodiment, the transistor data includes data from the sensors 206, empirical data, data determined from a finite element analysis of the compact model, or the like.

In one embodiment, the CM module 150 simulates power inputs to the FETs 202₁₋₂ (e.g., voltages applied to the gate contact 302, the sources, and the drains of the FETs 202₁₋₂), which causes current flow through the FETs 202₁₋₂ and the gate network 304. Further, the current flow can cause temperature changes in the thermal equivalence circuit model 300C, as described below.

The CM module 150 can also use the transistor data to establish operating parameters of resistors (e.g., shared first resistor R1, resistor R2, or resistor R3) of the gate network 304, or may otherwise determine electrical features of the FETs 202₁₋₂ that enable a peak performance or reliability operating range of the FETs 202₁₋₂. The method 400 ends at block 410.

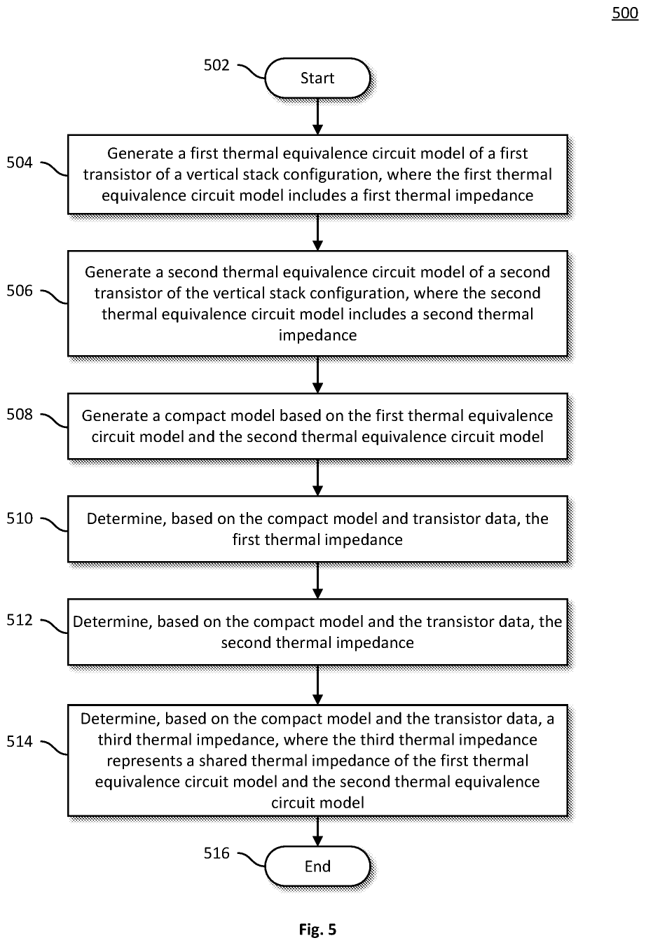

FIG. 3C illustrates a thermal equivalence circuit model 300C of a vertical stack configuration 204, according to one embodiment. FIG. 5 illustrates a flowchart of a method 500 of determining thermal impedances of a thermal equivalence circuit model 300 C of a vertical stack configuration 204, according to one embodiment. FIG. 3C is described in conjunction with FIG. 5.

In one embodiment, the method 500 is performed by the compact modeling (CM) module 150. The method 500 begins at block 502.

At block 504, the CM module 150 generates a first thermal equivalence circuit model of a first transistor of a vertical stack configuration 204, where the first thermal equivalence circuit model includes a first thermal impedance Z_{TH1}. In the embodiment illustrated in FIG. 3C, a first thermal equivalence circuit model is shown for FET 202₁.

The first thermal equivalence circuit model can include a first temperature measurement point T_{F1} of FET 202₁, the first thermal impedance Z_{TH1} (which includes a first thermal capacitor C_{TH1} and a first thermal resistor R_{TH1}), a first power source I_{D1} V_{DS1}, and a second temperature measurement point T_{S1} of FET 202₁. In one embodiment, the first temperature measurement point T_{F1} of FET 202₁ represents a temperature at a source, a drain, a channel, or a substrate of the FET 202₁. The second temperature measurement point T_{S1} of FET 202₁ can represent a temperature at an interface between the FETs 202₁₋₂.

At block 506, the CM module 150 generates a second thermal equivalence circuit model of a second transistor of the vertical stack configuration 204, where the second thermal equivalence circuit model includes a second thermal impedance Z_{TH2}. In the embodiment illustrated in FIG. 3C, a second thermal equivalence circuit model is shown for FET 202₂.

The second thermal equivalence circuit model can include a first temperature measurement point T_{F2} of FET 202₂, the second thermal impedance Z_{TH2} (which includes a second thermal capacitor C_{TH2} and a second thermal resistor R_{TH2}), a second power source I_{D2} V_{DS2}, and a second temperature measurement point T_{S2} of FET 202₂. In one embodiment, the first temperature measurement point T_{F2} of FET 202₂ represents a temperature at a source, a drain, a channel, or a substrate of the FET 202₂. The second temperature measurement point T_{S2} of FET 202₂ can represent a temperature at an interface between the FETs 202₁₋₂.

In one embodiment, the CM module generates the thermal equivalence circuit model 300C by connecting the first thermal equivalence circuit model and the second thermal equivalence model via a shared thermal resistor R_{ST} that represents shared temperature dynamics between the FETs 202₁₋₂. This process is described further below.

At block 508, the CM module 150 generates a compact model based on the first thermal equivalence circuit model and the second thermal equivalence circuit model. As previously discussed, a compact model can be a simulation model that represents electrical or thermal features of a transistor. In the embodiment illustrated in FIG. 3C, the compact model represents the thermal equivalence circuit model 300C. However, the compact model can be expanded to further represent the electrical equivalence circuit model 300B, such that the compact model represents both the electrical equivalence circuit model 300B and the thermal equivalence circuit model 300C.

At block 510, the CM module 150 determines, based on the compact model and transistor data, the first thermal impedance Z_{TH1} of the first thermal equivalence circuit model. As discussed above, the first thermal impedance Z_{TH1} includes a thermal resistance R_{TH1}, and a thermal capacitance C_{TH1}. The transistor data can include data from the sensors 206, empirical data, data determined from a finite element analysis of the compact model, or the like.

In one embodiment, the thermal resistance of the first thermal resistor R_{TH1} represents a capability of FET 202₁ to dissipate heat from a heat-generating junction during or after operation of the FET 202₁. The thermal capacitance of the first thermal capacitor C_{TH1} represents a capability of FET 202₁ to store or release heat, which determines the time needed for the FET 202₁ to increase or decrease in temperature in response to operation of the FET 202₁.

In one embodiment, the first thermal impedance Z_{TH1} is determined by comparing the transistor data (which includes sensor measurements at T_{F1} and T_{S1} at various times of operation and non-operation of the FET 202₁) to empirical data of thermal impedances, and determining corresponding thermal resistance values of the first thermal resistor R_{TH1} and thermal capacitance values of the first thermal capacitor C_{TH1}. For instance, the sensor measurements can be used as an index to look up corresponding thermal impedance values in a table of the empirical data, or a regression analysis may be performed to determine a set of values that best correlate the sensor measurements to the first thermal impedance values.

At block 512, the CM module 150 determines, based on the transistor data, the second thermal impedance of the second thermal equivalence circuit model. As discussed above, the second thermal impedance Z_{TH2} includes a thermal resistance R_{TH1}, and a thermal capacitance C_{TH1}.

In one embodiment, the thermal resistance of the second thermal resistor R_{TH2} represents a capability of FET 202₂ to dissipate heat from a heat-generating junction during or after operation of the FET 202₂. The thermal capacitance of the second thermal capacitor C_{TH2} represents a capability of FET 202₂ to store or release heat, which determines the time needed for the FET 202₂ to increase or decrease in temperature in response to operation of the FET 202₂.

In one embodiment, the second thermal impedance Z_{TH2} is determined by comparing the transistor data (which includes sensor measurements at T_{F2} and T_{G2} at various times of operation and non-operation of the FET 202₂) to empirical data of thermal impedances, and determining corresponding thermal resistance values of the second thermal resistor R_{TH2} and thermal capacitance values of the first thermal capacitor C_{TH2}. For instance, the sensor measurements can be used as an index to look up corresponding thermal impedance values in a table of the empirical data, or a regression analysis may be performed to determine set of values that best correlate the sensor measurements to the second thermal impedance values.

At block 514, the CM module 150 determines, based on the compact model and the transistor data, a third thermal impedance, where the third thermal impedance represents a shared thermal impedance of the first thermal equivalence circuit model and the second thermal equivalence circuit model. In one embodiment, the third thermal impedance captures temperature dynamics shared between the first thermal equivalence circuit model and the second thermal equivalence circuit model.

In one embodiment, the temperature dynamics represent the behavior of heat dissipated from one FET in the vertical stack configuration 204 to a vertically adjacent FET in the vertical stack configuration 204. Examples of the shared temperature dynamics can include temperature ranges, temperature changes, thermal resistances, thermal capacitances, or the like, of FETs 202_{1-N} of the vertical stack configuration 204.

In the embodiment illustrated in FIG. 3C, the first thermal equivalence circuit model and the second thermal equivalence circuit model are connected via a shared thermal resistor R_{ST}. In one embodiment, the third thermal impedance represents thermal impedances due to source-to-source proximity of the FETs 202₁₋₂, drain-to-drain proximity of the FETs 202₁₋₂, a gate network 304 shared by the FETs 202₁₋₂, or the like. The shared thermal resistor R_{ST} may also be represented by another circuit element.

In one embodiment, the third thermal impedance is determined by comparing the transistor data to operating data of FET 202₁ and FET 202₂. The transistor data can include heat measurements at the second temperature measurement point T_{S1} of FET 202₁, the second temperature measurement point T_{S2}, or the shared thermal resistor R_{ST}. Examples of the operating data include durations of operation or non-operation, transient and steady state power usage, maximum power usage, and the like.

The CM module 150 can use the heat measurements and the operating data to determine the temperature dynamics relative to the operation durations and power usage of the vertical stack configuration 204. In another embodiment, the CM module 150 can use the thermal impedances Z_{TH1} and Z_{TH2} to determine or estimate the thermal resistance of the shared thermal resistor R_{ST}. The method 500 ends at block 516.

FIG. 5 illustrates a flowchart of a method 600 generating a thermal characteristic datasheet of the vertical stack configuration 204, according to one embodiment. In one embodiment, the method 600 is performed by the compact modeling (CM) module 150. The method 600 begins at block 602.

At block 604, the CM module 150 receives the first thermal impedance Z_{TH1}, the second thermal impedance Z_{TH2}, and the third thermal impedance. At block 606, the CM module 150 trains a machine learning model to generate a thermal characteristic datasheet based on the first thermal impedance Z_{TH1}, the second thermal impedance Z_{TH2}, or the third thermal impedance.

In one embodiment, the first thermal impedance ZTH₁, the second thermal impedance Z_{TH2}, and the third thermal impedance are combined with data of other vertical stack configurations 204 and corresponding thermal impedances. The combined data can be used as training data to teach the machine learning model (via a supervised or unsupervised learning process) to generate thermal characteristic data when given features of the vertical stack configuration 204 (e.g., the thermal impedances, the number of transistors in the configuration, the types of transistors in the configuration, the order of the types in the vertical stack, the thermal impedances, or the like).

At block 608, the CM module 150 generates, via the machine learning model, the thermal characteristic datasheet of the vertical stack configuration 204. In one embodiment, the thermal datasheet of the vertical stack configuration includes data of thermal resistances, thermal capacitances, maximum junction temperatures, recommended operating conditions, power dissipation curves, heat sink recommendations, thermal equivalence models, sensor measurements, or the like, of the vertical stack configuration 204. The method 600 ends at block 610.

While the foregoing is directed to embodiments of the present invention, other and further embodiments of the invention may be devised without departing from the basic scope thereof, and the scope thereof is determined by the claims that follow.

What is claimed is:

1. A method comprising:
generating a first thermal equivalence circuit model of a first transistor of a vertical stack configuration, wherein the first thermal equivalence circuit model includes a first thermal impedance;
generating a second thermal equivalence circuit model of a second transistor of the vertical stack configuration, wherein the second thermal equivalence circuit model includes a second thermal impedance;
generating a compact model based on the first thermal equivalence circuit model and the second thermal equivalence circuit model;
determining, based on the compact model and transistor data, the first thermal impedance and the second thermal impedance; and
determining, based on the compact model and the transistor data, a third thermal impedance, wherein the third thermal impedance represents a shared thermal impedance of the first thermal equivalence circuit model and the second thermal equivalence circuit model.

2. The method of claim 1, further comprising:
generating an electrical equivalence circuit model of the first transistor and the second transistor, wherein the electrical equivalence circuit model includes a gate network, wherein the compact model is further generated based on the electrical equivalence circuit mode; and
determining, based on the compact model and the transistor data, impedances of the gate network.

3. The method of claim 2, wherein the gate network includes a shared first resistor, a second resistor, and a third resistor;
wherein the first transistor is connected to a gate contact via a first electrical path that includes the shared first resistor and the second resistor;
wherein the second transistor is connected to the gate contact via a second electrical path that includes the shared first resistor and the third resistor; and
wherein the compact model represents the electrical equivalence circuit model and a thermal equivalence circuit model that includes the first thermal equivalence circuit model and the second thermal equivalence circuit model connected via the third thermal impedance.

4. The method of claim 1, further comprising:
training a machine learning model to generate a thermal characteristic datasheet based on the first thermal impedance, the second thermal impedance, and the third thermal impedance; and
generating, via the machine learning model, the thermal characteristic datasheet of the vertical stack configuration.

5. The method of claim 1, wherein the first thermal equivalence circuit model includes a first temperature measurement point of the first transistor, the first thermal impedance, a first power source, and a second temperature measurement point of the first transistor, wherein the first temperature measurement point of the first transistor represents a temperature at a source of the first transistor, a drain of the first transistor, a channel of the first transistor, or a substrate of the first transistor, and wherein the second temperature measurement point of the first transistor represents a temperature at an interface between the first transistor and the second transistor; and
wherein the second thermal equivalence circuit model includes a first temperature measurement point of the second transistor, the second thermal impedance, a second power source, and a second temperature measurement point of the second transistor, wherein the first temperature measurement point of the second transistor represents a temperature at a source of the second transistor, a drain of the second transistor, a channel of the second transistor, or a substrate of the second transistor, and wherein the second temperature measurement point of the second transistor represents a temperature at an interface between the first transistor and second transistor.

6. The method of claim 1, wherein the vertical stack configuration comprises a gate contact disposed on the first transistor;
wherein the first transistor is disposed on the second transistor;
wherein the first transistor and the second transistor share a gate network; and
wherein power supplied to the second transistor causes power to be supplied to the first transistor.

7. The method of claim 1, wherein the third thermal impedance represents temperature dynamics shared between the first thermal equivalence circuit model and the second thermal equivalence circuit model, wherein the temperature dynamics represent a behavior of at least one of: heat dissipated from the first transistor to the second transistor, or heat dissipated from the second transistor to the first transistor; and wherein the temperature dynamics include transient temperatures generated during an operation of the first transistor or the second transistor.

8. A system, comprising:
a processor; and
memory or storage comprising an algorithm or computer instructions, which when executed by the processor, performs an operation comprising:
generating a first thermal equivalence circuit model of a first transistor of a vertical stack configuration, wherein the first thermal equivalence circuit model includes a first thermal impedance;
generating a second thermal equivalence circuit model of a second transistor of the vertical stack configuration, wherein the second thermal equivalence circuit model includes a second thermal impedance;
generating a compact model based on the first thermal equivalence circuit model and the second thermal equivalence circuit model;
determining, based on the compact model and transistor data, the first thermal impedance and the second thermal impedance; and
determining, based on the compact model and the transistor data, a third thermal impedance, wherein the third thermal impedance represents a shared thermal impedance of the first thermal equivalence circuit model and the second thermal equivalence circuit model.

9. The system of claim 8, the operation further comprising:
generating an electrical equivalence circuit model of the first transistor and the second transistor, wherein the electrical equivalence circuit model includes a gate network, wherein the compact model is further generated based on the electrical equivalence circuit mode; and
determining, based on the compact model and the transistor data, impedances of the gate network.

10. The system of claim 9, wherein the gate network includes a shared first resistor, a second resistor, and a third resistor;
wherein the first transistor is connected to a gate contact via a first electrical path that includes the shared first resistor and the second resistor;
wherein the second transistor is connected to the gate contact via a second electrical path that includes the shared first resistor and the third resistor; and
wherein the compact model represents the electrical equivalence circuit model and a thermal equivalence circuit model that includes the first thermal equivalence circuit model and the second thermal equivalence circuit model connected via the third thermal impedance.

11. The system of claim 8, the operation further comprising:
training a machine learning model to generate a thermal characteristic datasheet based on the first thermal impedance, the second thermal impedance, and the third thermal impedance; and
generating, via the machine learning model, the thermal characteristic datasheet of the vertical stack configuration.

12. The system of claim 8, wherein the first thermal equivalence circuit model includes a first temperature measurement point of the first transistor, the first thermal impedance, a first power source, and a second temperature measurement point of the first transistor, wherein the first temperature measurement point of the first transistor represents a temperature at a source of the first transistor, a drain of the first transistor, a channel of the first transistor, or a substrate of the first transistor, and wherein the second temperature measurement point of the first transistor represents a temperature at an interface between the first transistor and the second transistor; and
wherein the second thermal equivalence circuit model includes a first temperature measurement point of the second transistor, the second thermal impedance, a second power source, and a second temperature measurement point of the second transistor, wherein the first temperature measurement point of the second transistor represents a temperature at a source of the second transistor, a drain of the second transistor, a channel of the second transistor, or a substrate of the second transistor, and wherein the second temperature measurement point of the second transistor represents a temperature at an interface between the first transistor and second transistor.

13. The system of claim 8, wherein the vertical stack configuration comprises a gate contact disposed on the first transistor;
wherein the first transistor is disposed on the second transistor;
wherein the first transistor and the second transistor share a gate network; and
wherein power supplied to the second transistor causes power to be supplied to the first transistor.

14. The system of claim 8, wherein the third thermal impedance represents temperature dynamics shared between the first thermal equivalence circuit model and the second thermal equivalence circuit model, wherein the temperature dynamics represent a behavior of at least one of: heat dissipated from the first transistor to the second transistor, or heat dissipated from the second transistor to the first transistor; and wherein the temperature dynamics include transient temperatures generated during an operation of the first transistor or the second transistor.

15. A computer-readable storage medium having a computer-readable program code embodied therewith, the computer-readable program code executable by one or more computer processors to perform an operation comprising:
generating a first thermal equivalence circuit model of a first transistor of a vertical stack configuration, wherein the first thermal equivalence circuit model includes a first thermal impedance;
generating a second thermal equivalence circuit model of a second transistor of the vertical stack configuration, wherein the second thermal equivalence circuit model includes a second thermal impedance;
generating a compact model based on the first thermal equivalence circuit model and the second thermal equivalence circuit model;
determining, based on the compact model and transistor data, the first thermal impedance and the second thermal impedance; and
determining, based on the compact model and the transistor data, a third thermal impedance, wherein the third thermal impedance represents a shared thermal impedance of the first thermal equivalence circuit model and the second thermal equivalence circuit model.

16. The computer-readable storage medium of claim 15, the operation further comprising:
generating an electrical equivalence circuit model of the first transistor and the second transistor, wherein the electrical equivalence circuit model includes a gate network, wherein the compact model is further generated based on the electrical equivalence circuit mode; and
determining, based on the compact model and the transistor data, impedances of the gate network.

17. The computer-readable storage medium of claim 16, wherein the gate network includes a shared first resistor, a second resistor, and a third resistor;
wherein the first transistor is connected to a gate contact via a first electrical path that includes the shared first resistor and the second resistor;
wherein the second transistor is connected to the gate contact via a second electrical path that includes the shared first resistor and the third resistor; and
wherein the compact model represents the electrical equivalence circuit model and a thermal equivalence circuit model that includes the first thermal equivalence circuit model and the second thermal equivalence circuit model connected via the third thermal impedance.

18. The computer-readable storage medium of claim 15, the operation further comprising:
training a machine learning model to generate a thermal characteristic datasheet based on the first thermal impedance, the second thermal impedance, and the third thermal impedance; and
generating, via the machine learning model, the thermal characteristic datasheet of the vertical stack configuration.

19. The computer-readable storage medium of claim 15, wherein the first thermal equivalence circuit model includes a first temperature measurement point of the first transistor, the first thermal impedance, a first power source, and a second temperature measurement point of the first transistor, wherein the first temperature measurement point of the first transistor represents a temperature at a source of the first transistor, a drain of the first transistor, a channel of the first transistor, or a substrate of the first transistor, and wherein the second temperature measurement point of the first transistor represents a temperature at an interface between the first transistor and the second transistor; and
wherein the second thermal equivalence circuit model includes a first temperature measurement point of the second transistor, the second thermal impedance, a second power source, and a second temperature measurement point of the second transistor, wherein the first temperature measurement point of the second transistor represents a temperature at a source of the second transistor, a drain of the second transistor, a channel of the second transistor, or a substrate of the second transistor, and wherein the second temperature measurement point of the second transistor represents a temperature at an interface between the first transistor and second transistor.

20. The computer-readable storage medium of claim 15, wherein the vertical stack configuration comprises a gate contact disposed on the first transistor;
wherein the first transistor is disposed on the second transistor;
wherein the first transistor and the second transistor share a gate network; and
wherein power supplied to the second transistor causes power to be supplied to the first transistor.

21. The computer-readable storage medium of claim 15, wherein the third thermal impedance represents temperature dynamics shared between the first thermal equivalence circuit model and the second thermal equivalence circuit model, wherein the temperature dynamics represent a behavior of at least one of: heat dissipated from the first transistor to the second transistor, or heat dissipated from the second transistor to the first transistor; and wherein the temperature dynamics include transient temperatures generated during an operation of the first transistor or the second transistor.

22. A system, comprising:
a processor; and
memory or storage comprising an algorithm or computer instructions, which when executed by the processor, performs an operation comprising:
generating an electrical equivalence circuit model of a first transistor and a second transistor of a vertical stack configuration, wherein the electrical equivalence circuit model includes a gate network shared between the first transistor and the second transistor;
generating a compact model based on the electrical equivalence circuit mode; and
determining, based on the compact model and transistor data, impedances of the gate network.

23. The system of claim 22, the operation further comprising:
generating a first thermal equivalence circuit model of the first transistor, wherein the first thermal equivalence circuit model includes a first thermal impedance;
generating a second thermal equivalence circuit model of the second transistor, wherein the second thermal equivalence circuit model includes a second thermal impedance, wherein the compact model is further generated based on the first thermal equivalence circuit model and the second thermal equivalence circuit model;
determining, based on the compact model and the transistor data, the first thermal impedance and the second thermal impedance; and
determining, based on the compact model and the transistor data, a third thermal impedance, wherein the third thermal impedance represents a shared thermal impedance of the first thermal equivalence circuit model and the second thermal equivalence circuit model.

24. A computer-readable storage medium having a computer-readable program code embodied therewith, the computer-readable program code executable by one or more computer processors to perform an operation comprising:
generating an electrical equivalence circuit model of a first transistor and a second transistor of a vertical stack configuration, wherein the electrical equivalence circuit model includes a gate network shared between the first transistor and the second transistor;
generating a compact model based on the electrical equivalence circuit mode; and
determining, based on the compact model and transistor data, impedances of the gate network.

25. The computer-readable storage medium of claim 24, the operation further comprising:
generating a first thermal equivalence circuit model of the first transistor, wherein the first thermal equivalence circuit model includes a first thermal impedance;
generating a second thermal equivalence circuit model of the second transistor, wherein the second thermal equivalence circuit model includes a second thermal impedance, wherein the compact model is further generated based on the first thermal equivalence circuit model and the second thermal equivalence circuit model;
determining, based on the compact model and the transistor data, the first thermal impedance and the second thermal impedance; and
determining, based on the compact model and the transistor data, a third thermal impedance, wherein the third thermal impedance represents a shared thermal impedance of the first thermal equivalence circuit model and the second thermal equivalence circuit model.
